(19) United States
(12) Patent Application Publication
(10) Pub. No.: US 2013/0219279 A1
(43) Pub. Date: Aug. 22, 2013

(54) AGGREGATING NODES FOR EFFICIENT NETWORK MANAGEMENT SYSTEM VISUALIZATION AND OPERATIONS

(71) Applicants: Francis Xavier Reichmeyer, Madison, CT (US); William James Sullivan, North Grafton, MA (US); David Campbell Taylor, Holliston, MA (US); Ramdas Sitaram Rao, Brighton, MA (US)

(72) Inventors: Francis Xavier Reichmeyer, Madison, CT (US); William James Sullivan, North Grafton, MA (US); David Campbell Taylor, Holliston, MA (US); Ramdas Sitaram Rao, Brighton, MA (US)

(73) Assignee: AMBIENT CORPORATION, Newton, MA (US)

(21) Appl. No.: 13/400,948

(22) Filed: Feb. 21, 2012

(51) Int. Cl. G06F 1/28; G06F 3/048; G06F 15/16

(52) U.S. Cl. 715/736

(57) ABSTRACT

There is provided a method that includes (a) accessing a data structure that (i) represents a plurality of nodes in an electrical power grid, and (ii) contains data indicative of an event reported by a node in the plurality of nodes, and (b) presenting, on a user interface, an element that represents the plurality of nodes, in aggregate, and indicates an existence of the event. There is also provided a system that performs the method, and a storage medium that contains instructions that cause a processor to execute the method.

### BACKGROUND OF THE INVENTION

1. Field of the Invention

The present invention relates generally to operational management and status monitoring systems for networked devices, and in particular to network management systems that enable users to perform management operations on and visualize status of networked devices in a power distribution system.

2. Description of the Related Art

A power distribution system, or power grid, carries power from various types of power generators to residential and commercial buildings such as houses, malls, and sports arenas. Power is carried by power lines from generators to substation facilities, between substation facilities, from substation facilities to transformers, and from transformers to residential and commercial buildings. Power utility companies, or utilities, must monitor operational status information for many types of components in power grids. Utilities often rely on reports from customers and field technicians to gather operational status information.

A smart grid is a power grid enhanced by the addition of computing devices called nodes that gather and distribute information about power grid components in order to improve the efficiency and reliability of the power grid. Nodes can be attached to power grid components such as transformers mounted on pole-tops or concrete pads, street lamps, and other break points in power lines. Nodes analyze power passing through power grid components to which they are attached and communicate with network management systems over a data network. Utilities use network management systems to perform management operations on nodes and to monitor operational status information for nodes and power grid components.

However, nodes can be so numerous in a smart grid that it can be difficult for a network management system, according to the current state of the art, to perform management operations and display status information for the nodes. In particular, two problems may be encountered when managing large numbers of nodes: difficulty in visualizing data representing large numbers of nodes, and performance degradation resulting from processing data representing large numbers of nodes. For example, in a case where a fault causes many nodes to concurrently report errors, if all of the nodes are individually represented on a display, and if each error is represented by an error indicator associated with its node, the display would be heavily populated with error indicators, thus making it difficult for a person viewing the display to recognize a possible source of the fault. There is therefore a need for methods for network management system that will solve these two problems.

### SUMMARY OF THE INVENTION

There is provided a method that includes (a) accessing a data structure that (i) represents a plurality of nodes in an electrical power grid, and (ii) contains data indicative of an event reported by a node in the plurality of nodes, and (b) presenting, on a user interface, an element that represents the plurality of nodes, in aggregate, and indicates an existence of the event. There is also provided a system that performs the method, and a storage medium that contains instructions that cause a processor to execute the method.

The present invention includes methods for a network management system (NMS) that provide data structures representing a hierarchy of aggregations and functionality that provides efficient management operations and information visualization for aggregations at each level of the hierarchy. Each aggregation at a first level of a hierarchy contains data structures that represent nodes, and each aggregation at an upper level of the hierarchy contains aggregations from the next lower level of the hierarchy. The NMS can send commands to nodes, including commands to reboot, upgrade firmware, modify internal parameter values, and send back stored data; nodes can send the NMS pulled data, such as responses to commands, and pushed data, such as status messages. The hierarchy of aggregations improves the usability and performance of these management operations and the ability to visualize related data.

A status message is a report of an event sent by a node to the NMS, and conveys status information for the node or for a power grid component to which the node is attached. Status of a node is a function of all status messages sent by the node; status of a first-level aggregation of nodes is a function of all status messages sent by all nodes in the first-level aggregation; status of a second-level aggregation of first-level aggregations of nodes is a function of all status messages sent by all nodes in all first-level aggregations in the second-level aggregation; status of a third-level aggregation of second-level aggregations of first-level aggregations of nodes is a function of all status messages sent by all nodes in all first-level aggregations in all second-level aggregations in the third-level aggregation; and so on.

A first method is provided to add a node data structure to data structures representing a hierarchy of aggregations in response to location information sent by a node. A second method is provided to gather all status messages received from nodes that are relevant to status of a node or an aggregation and to summarize status information conveyed by the gathered status messages. With these methods, the NMS can display summarized status information for a node or an aggregation in a way that reduces visualization difficulties and performance degradation.

### BRIEF DESCRIPTION OF THE DRAWINGS

FIG. 1 is a block diagram of an exemplary system of nodes deployed in a power grid, arranged in subsystems of circuits, substations, and regions, and communicating with a network management system over a data network.

FIG. 2 is a block diagram of an exemplary architecture of a network management system, including the communications between the network management system and nodes deployed in a power grid.

FIG. 3 is a block diagram of a data structure that contains an exemplary hierarchy of aggregations that represent power grid subsystems.

FIGS. 4a, 4b, and 4c are collectively a flowchart of a method implemented by a network management system for adding a data structure representing a node to a data structure containing an exemplary hierarchy of aggregations that represent power grid subsystems.

FIGS. 5a, 5b, 5c, and 5d are collectively a flowchart of a method implemented by a network management system for creating a status indicator to summarize status information conveyed by all status messages sent by all nodes relevant to a status request made by a user.

FIGS. 6a, 6b, 6c, and 6d are illustrations of maps depicting status indicators for an exemplary hierarchy of aggregations that represent states, cities, and zip codes.

FIG. 7 is a screenshot of a series of lists depicting status indicators for an exemplary hierarchy of aggregations that represent states, cities, and zip codes.

### DESCRIPTION OF THE INVENTION

The present invention includes methods for a network management system (NMS) that provide data structures representing a hierarchy of aggregations and functionality that provides efficient management operations and information visualization for aggregations at each level of the hierarchy. Each aggregation at a first level of a hierarchy contains data structures that represent nodes, and each aggregation at an upper level of the hierarchy contains aggregations from the next lower level of the hierarchy. The NMS can send commands to nodes, including commands to reboot, upgrade firmware, modify internal parameter values, and send back stored data; nodes can send the NMS both pulled data, such as responses to commands, and pushed data, such as status messages. In one embodiment, status messages are Simple Network Management Protocol (SNMP) messages.

Another embodiment includes a hierarchy of aggregations that represent commonly known geographical concepts, with a first level of aggregations that represent cities, a second level of aggregations that represent counties, and a third level of aggregations that represent states. A city aggregation is a data structure that contains node data structures representing nodes attached to power grid components, such as transformers. A county aggregation is a data structure that contains city aggregations. A state aggregation is a data structure that contains county aggregations.

Another embodiment includes a hierarchy of aggregations that represent power grid subsystems, with a first level of aggregations that represent circuits, a second level of aggregations that represent substations, and a third level of aggregations that represent regions. A circuit aggregation is a data structure that contains node data structures representing nodes attached to transformers that form a circuit, i.e. that are connected to each other and to a substation facility by a power line. A substation aggregation is a data structure that contains circuit aggregations representing circuits that share a common substation facility. A region aggregation is a data structure that contains substation aggregations representing substations located in a power grid region.

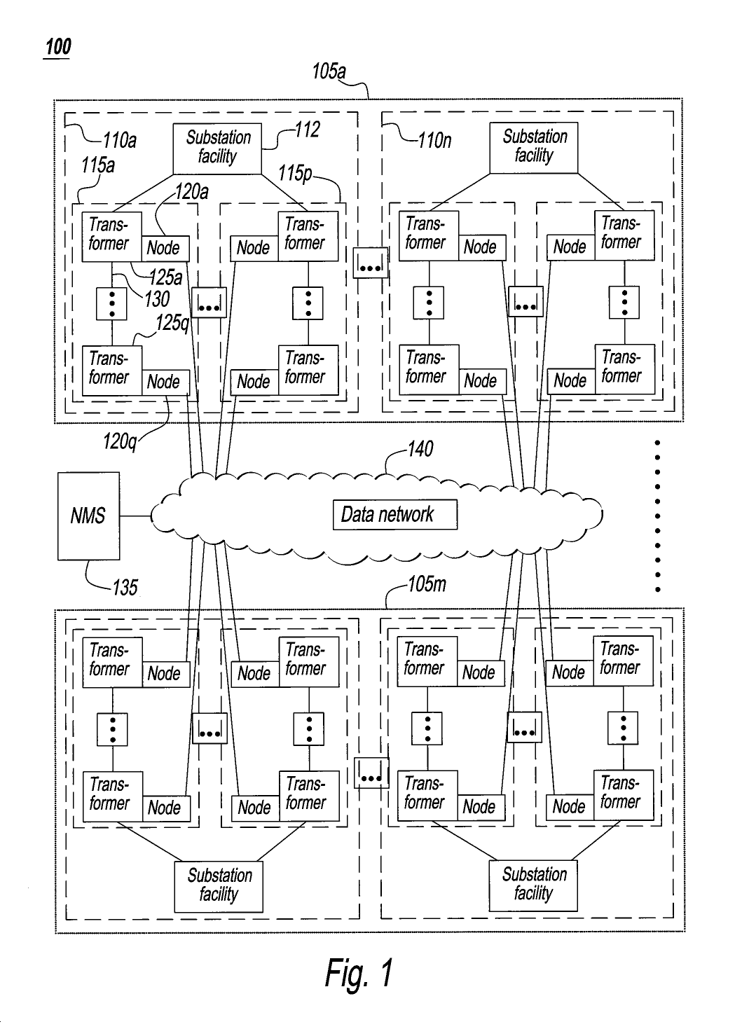

FIG. 1 is a block diagram of an exemplary system 100 of nodes deployed in a power grid, arranged in subsystems of circuits, substations, and regions, and communicating with an NMS over a data network. Each of a node 120a through a node 120q is connected to a transformer 125a through a transformer 125q, respectively, and can communicate over a data network 140 with an NMS 135. Transformer 125a through transformer 125q are connected to each other and to a substation facility 112 by a power line 130, forming a circuit 115a. Circuit 115a through a circuit 115p share common substation facility 112 and form a substation 110a. Substation 110a through a substation 110n are located in a region 105a. Similar power grid subsystems exist in region 105a through a region 105m.

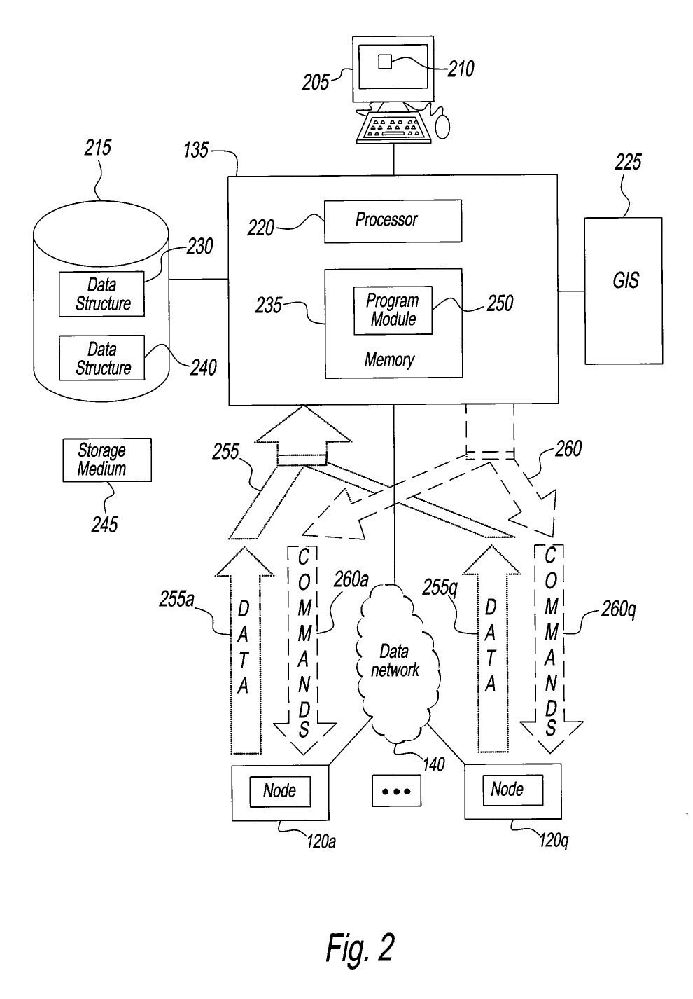

FIG. 2 is a block diagram of an exemplary architecture of NMS 135, which is a computing device that includes a processor 220, and a memory 235, and is communicatively coupled to a database 215, a user interface 205 and a geographic information system (GIS) 225. Database 215 contains a data structure 230 and data structure 240.

Processor 220 is an electronic device configured of logic circuitry that responds to and executes instructions.

Memory 235 is a tangible computer-readable storage medium encoded with a computer program. In this regard, memory 235 stores data and instructions that are readable and executable by processor 220 for controlling the operation of processor 220. Memory 235 may be implemented in a random access memory (RAM), a hard drive, a read-only memory (ROM), or a combination thereof. One of the components of memory 235 is a program module 250.

Program module 250 contains instructions for controlling processor 220 to execute methods described herein. The term “module” is used herein to denote a functional operation that may be embodied either as a stand-alone component or as an integrated configuration of a plurality of subordinate components. Thus, program module 250 may be implemented as a single module or as a plurality of modules that operate in cooperation with one another. Moreover, although program module 250 is described herein as being installed in memory 235, and therefore being implemented in software, it could be implemented in any of hardware (e.g., electronic circuitry), firmware, software, or a combination thereof.

While program module 250 is indicated as already loaded into memory 235, it may be configured on a storage medium 245 for subsequent loading into memory 235. Storage medium 245 is a tangible computer-readable storage medium and can be any conventional storage medium that stores program module 250 thereon in tangible form. Examples of storage medium 245 include a compact disk, a magnetic tape, a read only memory, an optical storage media, a hard drive or a memory unit consisting of multiple parallel hard drives, and a universal serial bus (USB) flash drive. Alternatively, storage medium 245 can be a random access memory, or other type of electronic storage device, located on a remote storage system and coupled to NMS 135 via data network 140.

NMS 135 receives input from and displays output on user interface 205, including a user interface element 210. NMS 135 sends queries to and receives responses from GIS 225. NMS 135 sends an aggregate command 260 by sending each of a command 260a through a command 260q to node 120a through node 120q, respectively. Each of node 120a through node 120q sends a data message 255a through a data message 255q, respectively, to NMS 135 that NMS 135 operates on as an aggregate data message 255. Data messages 255a through 255q include status messages, which are reports of events.

In another embodiment (not shown), NMS 135 includes multiple computing devices in a client-server arrangement, where a server computing device performs database functions and one or more client computing devices each perform user interface functions for separate user interfaces.

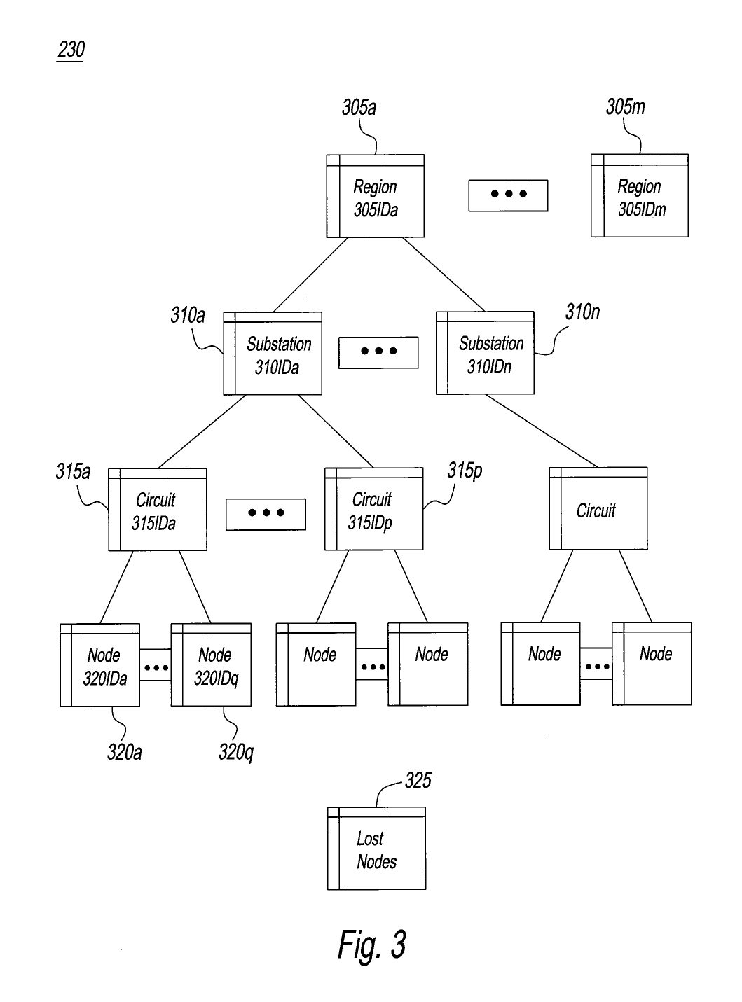

FIG. 3 is a block diagram of data structure 230, which contains an exemplary hierarchy of aggregations representing power grid subsystems. Data structure 230 includes a region object 305a through a region object 305m, which each respectively contains a region ID 305IDa through a region ID 305IDm and represents region 105a through region 105m. Region object 305a is linked to each of a substation object 310a through a substation object 310n, which each respectively contains a substation ID 310IDa through a substation ID 310IDn and represents substation 110a through substation 110n.

Substation object 310a is linked to each of a circuit object 315a through a circuit object 315p, which each respectively contains a circuit ID 315IDa through a circuit ID 315IDp and represents circuits 115a through 115p.

Circuit object 315a is linked to each of a node object 320a through a node object 320q, which each respectively contains a node ID 320IDa through a node ID 320IDq and represents node 120a through node 120q. Data structure 230 also includes a Lost Nodes object 325.

In another embodiment (not shown), data structure 240 contains an exemplary hierarchy of aggregations that represent commonly known geographic concepts including states, counties, and cities and is otherwise similar in structure to data structure 230.

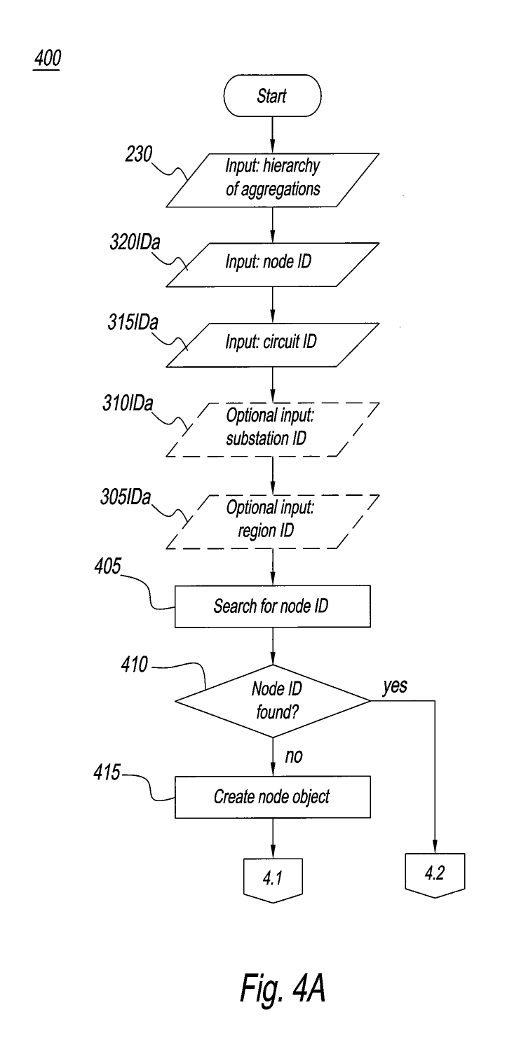

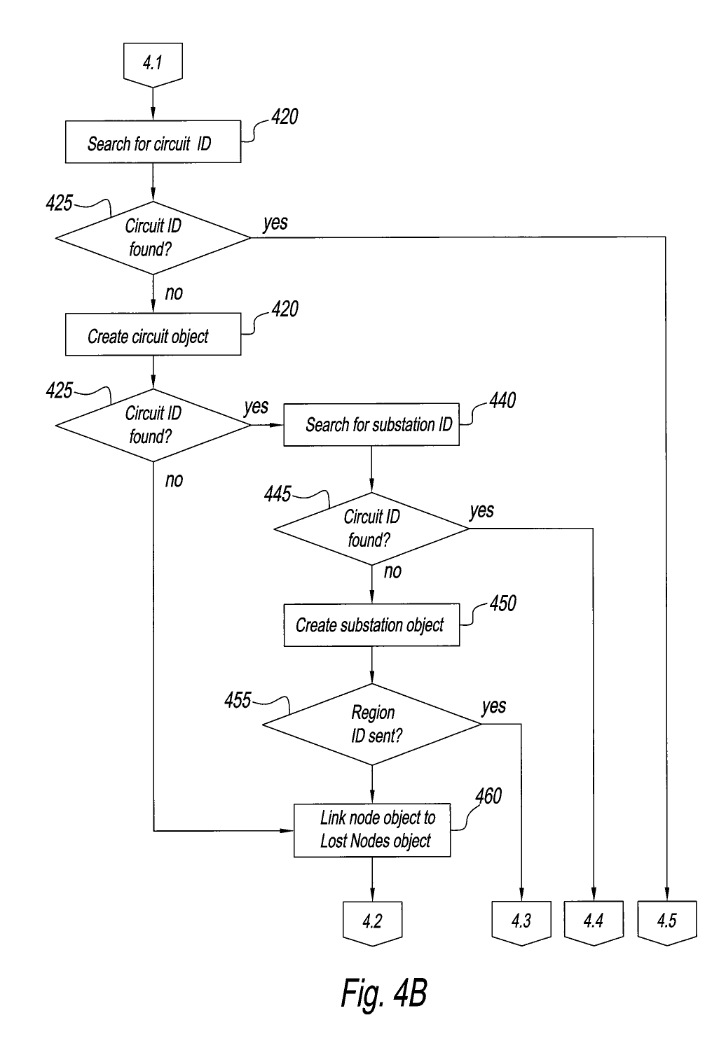

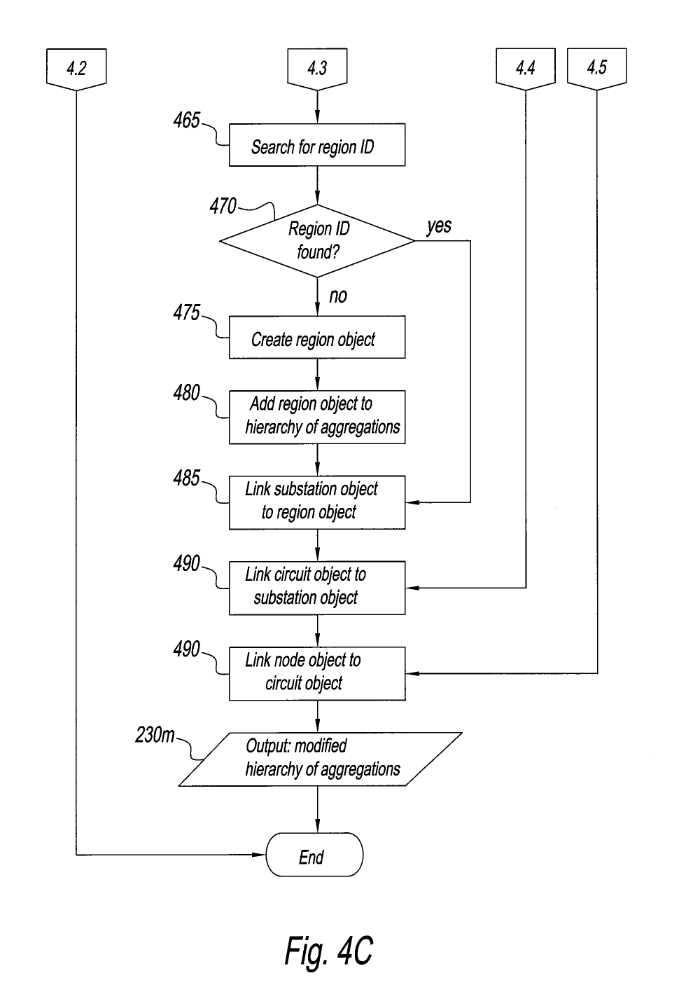

FIGS. 4a, 4b, and 4c are collectively a flowchart of a method 400 implemented by NMS 135, and more specifically performed by processor 220, for adding a data structure for a node to data structure 230. In one embodiment, method 400 adds node 120a to data structure 230 when node 120a sends data to NMS 135 after node 120a has been powered up; however, some of the branches in method 400 will not execute except in embodiments where node object 320a, circuit object 315a, substation object 310a, and/or region object 305a are not yet in data structure 230.

Data structure 230 is input to method 400.

Node ID 320IDa and circuit ID 315IDa, and optionally substation ID 310IDa and region ID 305IDa, i.e., data that NMS 135 receives from node 120a, are inputs to method 400. Node 120a is configured with the values for node ID 320IDa, circuit ID 315IDa, substation ID 310IDa, and region ID 305IDa before node 120a is installed.

In step 405, method 400 searches data structure 230 for node ID 320IDa and goes to step 410.

In step 410, in an embodiment where node ID 320IDa is found in data structure 230, method 400 goes to connector 4.2 and ends; otherwise, method 400 goes to step 415.

In step 415, method 400 creates node object 320a, containing node ID 320IDa, and goes to connector 4.1 and on to step 420.

In step 420, method 400 searches data structure 230 for circuit ID 315IDa and goes to step 425.

In step 425, in an embodiment where circuit ID 315IDa is found in data structure 230, method 400 goes to connector 4.5 and on to step 495; otherwise, method 400 goes to step 430.

In step 430, method 400 creates circuit object 315a, containing circuit ID 315IDa, and goes to step 435.

In step 435, if substation ID 310IDa was included in input data from node 120a, then method 400 goes to step 440; otherwise, method 400 goes to step 460.

In step 440, method 400 searches data structure 230 for substation ID 310IDa and goes to step 445.

In step 445, in an embodiment where substation ID 310IDa is found in data structure 230, then method 400 goes to connector 4.4 and on to step 490; otherwise, method 400 goes to step 450.

In step 450, method 400 creates substation object 310a, containing substation ID 310IDa, and goes to step 455.

In step 455, if region ID 305IDa was included in input data from node 120a, then method 400 goes to connector 4.3 and on to step 465; otherwise, method 400 goes to step 460.

In step 460, method 400 links newly created node object 320a to Lost Nodes object 325 and goes to connector 4.2 and ends.

In step 465, method 400 searches data structure 230 for region ID 305IDa and goes to step 470.

In step 470, in an embodiment where region ID 305IDa is found in data structure 230, then method 400 goes to step 485; otherwise, method 400 goes to step 475.

In step 475, method 400 creates region object 305a, containing region ID 305IDa, and goes to step 480.

In step 480, method 400 adds newly created region object 305a to data structure 230 and goes to step 485.

In step 485, method 400 links newly created substation object 310a to region object 305a in data structure 230 and goes to step 490.

In step 490, method 400 links newly created circuit object 315a to substation object 310a in data structure 230 and goes to step 495.

In step 495, method 400 links newly created node object 320a to circuit object 315a in data structure 230.

Modified data structure 230m is output from method 400.

In another embodiment, NMS 135 implements an alternative method (not shown), similar to method 400, for adding node 120a to data structure 240. Instead of sending circuit ID 315IDa and possibly substation ID 310IDa and region ID 305IDa, node 120a sends a longitude and a latitude; the alternative method uses these to query GIS 225 and gets back a city ID, a county ID, and a state ID. The alternative method then follows logic similar to method 400 to add node 120a to data structure 240, substituting the city ID, county ID, and state ID for circuit ID 315IDa, substation ID 310IDa, and region ID 305IDa, respectively. Node 120a can be configured with longitude and latitude values before node 120a is installed, or node 120a can retrieve longitude and latitude values using a global positioning system (GPS) module (not shown).

In one embodiment, NMS 135 enables a user to send aggregate command 260 to circuit 115a by using data structure 230 to send command 260a through command 260q to node 120a through node 120q, respectively. NMS 135 also enables a user to visualize aggregate data message 255 from circuit 115a by using data structure 230 to create aggregate data message 255 from data message 255a through data message 255q received from node 120a through node 120q, respectively. An example of aggregate data message 255 is status information for circuit 115a that NMS 135 creates from status information received from node 120a through node 120q.

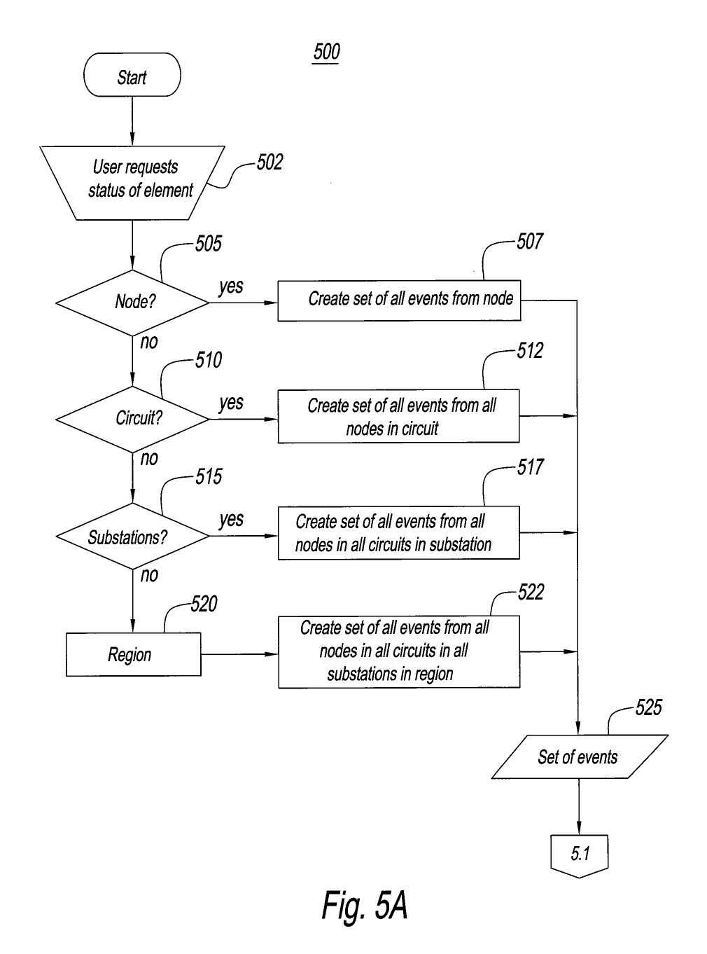

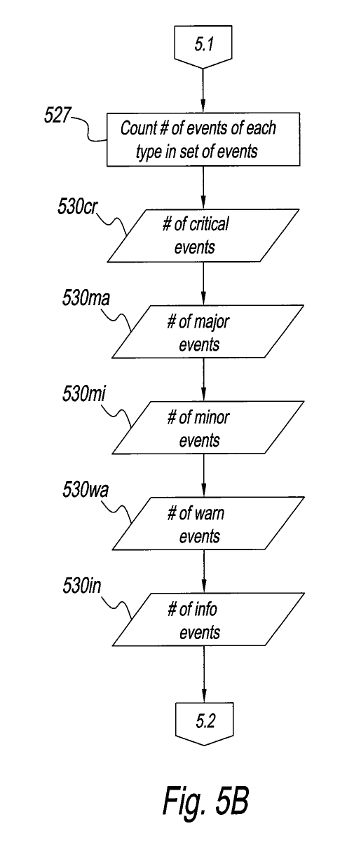

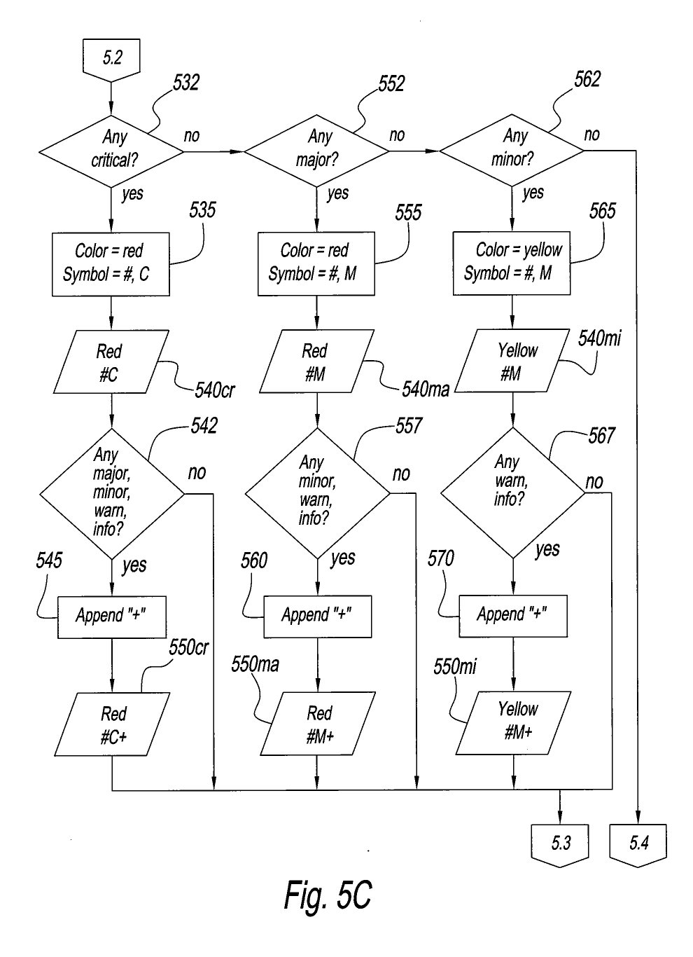

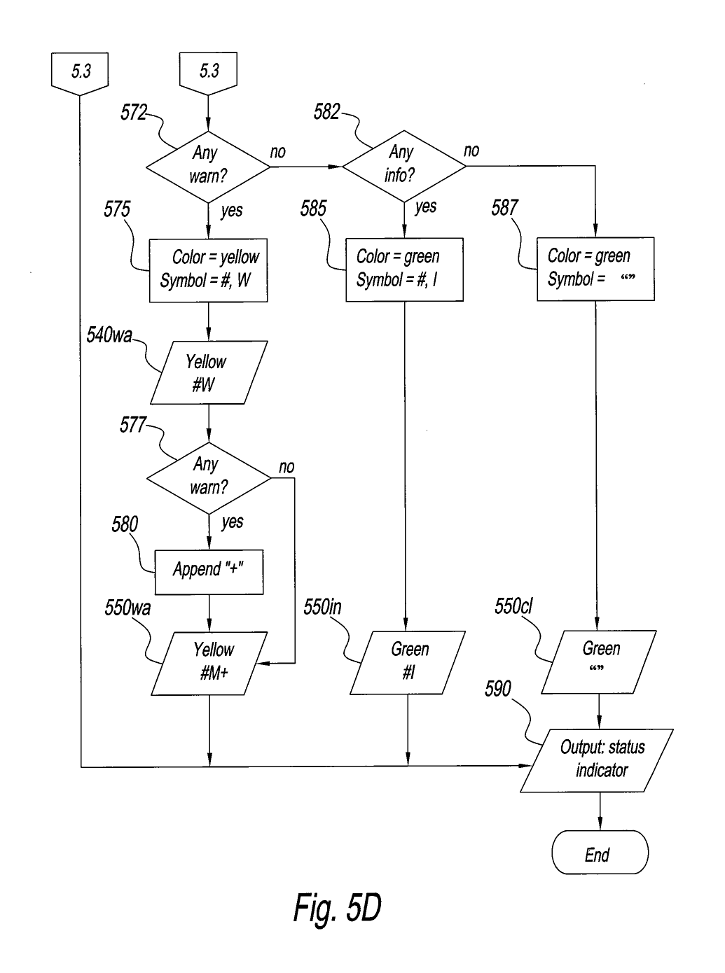

FIGS. 5a, 5b, 5c, and 5d are collectively a flowchart of a method 500 implemented by NMS 135, and more specifically performed by processor 220, for creating a status indicator to efficiently summarize status information conveyed by all status messages sent by all nodes relevant to a status request made by a user. In one embodiment, a status request refers to either node 120a, circuit 115a, substation 110a, or region 105a; node 120a or other nodes in circuit 115a or substation 110a or region 105a might have previously sent status messages to notify NMS 135 that grid power dropped or was restored.

In brief, method 500 includes (a) accessing a data structure that (i) represents a plurality of nodes in an electrical power grid, and (ii) contains data indicative of an event reported by a node in the plurality of nodes, and (b) presenting, on a user interface, an element that represents the plurality of nodes, in aggregate, and indicates an existence of the event. For example, method 500 (a) accesses data structure 230, which (i) represents a plurality of nodes in an electrical power grid, and (ii) contains data indicative of an event reported by node 120a, and (b) presents, on user interface 205, user interface element 210, which represents the plurality of nodes, in aggregate, and indicates an existence of the event.

Table 1 lists exemplary status message types, status colors, and status labels used to create status indicators that may be presented by user interface element 210. Status message types are listed in Table 1 in increasing order of severity, and each status message type is mapped to a status color and a status label. There is no status label for the clear status message type. The status label for the informational status message type is a numeral followed by the letter “I”. The status label for each other status message type is a numeral, followed by the specified letter, and followed, conditionally, by a plus sign. That is, depending on certain conditions, the plus sign may, or may not, be included.

TABLE 1

| Message type | Color | Label |
|---|---|---|
| Clear | Green | N/A |
| Informational | Green | #I |
| Warning | Yellow | #W[+] |
| Minor | Yellow | #M[+] |
| Major | Red | #M[+] |
| Critical | Red | #C[+] |

In step 502, a user has requested status of user interface element 210. Method 500 goes to step 505.

In step 505, if user interface element 210 represents node 120a, then method 500 goes to step 507; otherwise, method 500 goes to step 510.

In step 507, method 500 populates a set 525 with all status messages sent by node 120a and goes to connector 5.1 and on to step 527.

In step 510, if user interface element 210 represents circuit 115a, then method 500 goes to step 512; otherwise, method 500 goes to step 515.

In step 512, method 500 populates set 525 with all status messages sent by node 120a through node 120q, i.e., all nodes in circuit 115a, and goes to connector 5.1 and on to step 527.

In step 515, if user interface element 210 represents substation 110a, then method 500 goes to step 517; otherwise, method 500 goes to step 520.

In step 517, method 500 populates set 525 with all status messages sent by node 120a through node 120q, i.e., all nodes in circuit 115a, and so on for all nodes in circuit 115a through circuit 115p, i.e., all circuits in substation 110a, and goes to connector 5.1 and on to step 527.

In step 520, user interface element 210 represents region 105a, and method 500 goes to step 522.

In step 522, method 500 populates set 525 with all status messages sent by node 120a through node 120q, i.e., all nodes in circuit 115a, and so on for all nodes in circuit 115a through circuit 115p, i.e., all circuits in substation 110a, and so on for all circuits in substation 110a through substation 110n, i.e., all substations in region 105a, and goes to connector 5.1 and on to step 527.

In step 527, method 500 counts the members of set 525 to find a number of status messages of each status message type listed in Table 1, producing a number of critical status events 530cr, a number of major status events 530ma, a number of minor status events 530mi, a number of warning status events 530wa, and a number of informational status events 530in. Method 500 then goes to connector 5.2 and on to step 532.

In step 532, if number of critical status events 530cr is greater than zero, then method 500 goes to step 535; otherwise, method 500 goes to step 552.

In step 535, method 500 uses a status color of red and a status label of “C” appended to number of critical status events 530cr to make partial status indicator 540cr and goes to step 542.

In step 542, if any of number of major status events 530ma, number of minor status events 530mi, number of warning status events 530wa, or number of informational status events 530in is greater than zero, i.e., if there are any status messages other than critical status messages, then method 500 goes to step 545; otherwise, method 500 goes to connector 5.3, produces output 590 equal to status indicator 540cr, and ends.

In step 545, method 500 appends a plus symbol to partial status indicator 540cr to make status indicator 550cr, goes to connector 5.3, produces output 590 equal to status indicator 550cr, and ends.

In step 552, if number of major status events 530ma is greater than zero, then method 500 goes to step 555; otherwise, method 500 goes to step 562.

In step 555, method 500 uses a status color of red and a status label of “M” appended to number of major status events 530ma to make partial status indicator 540ma and goes to step 557.

In step 557, if any of number of minor status events 530mi, number of warning status events 530wa, or number of informational status events 530in is greater than zero, i.e., if there are any status messages other than major status messages, then method 500 goes to step 560; otherwise, method 500 goes to connector 5.3, produces output 590 equal to status indicator 540ma, and ends.

In step 560, method 500 appends a plus symbol to partial status indicator 540ma to make status indicator 550ma and goes to connector 5.3, produces output 590 equal to status indicator 550ma, and ends.

In step 562, if number of minor status events 530mi is greater than zero, then method 500 goes to step 565; otherwise, method 500 goes to connector 5.4 and on to step 572.

In step 565, method 500 uses a status color of yellow and a status label of “M” appended to number of minor status events 530mi to make partial status indicator 540mi and goes to step 567.

In step 567, if either of number of warning status events 530wa or number of informational status events 530in is greater than zero, i.e., if there are any status messages other than minor status messages, then method 500 goes to step 570; otherwise, method 500 goes to connector 5.3, produces output 590 equal to status indicator 540mi, and ends.

In step 570, method 500 appends a plus symbol to partial status indicator 540mi to make status indicator 550mi, goes to connector 5.3, produces output 590 equal to status indicator 550mi, and ends.

In step 572, if number of warning status events 530wa is greater than zero, then method 500 goes to step 575; otherwise, method 500 goes to step 582.

In step 575, method 500 uses a status color of yellow and a status label of “W” appended to number of warning status events 530wa to make partial status indicator 540wa and goes to step 577.

In step 577, if number of informational status events 530in is greater than zero (i.e. if there are any status messages other than warning status messages), then method 500 goes to step 580; otherwise, method 500 produces output 590 equal to status indicator 540wa, and ends.

In step 580, method 500 appends a plus symbol to partial status indicator 540wa to make status indicator 550wa, produces output 590 equal to status indicator 550wa, and ends.

In step 582, if number of informational status events 530in is greater than zero, then method 500 goes to step 585; otherwise, method 500 goes to step 587.

In step 585, method 500 uses a status color of green and a status label of “I” appended to number of informational status events 530in to make status indicator 550in, produces output 590 equal to status indicator 550in, and ends.

In step 587, method 500 uses a status color of green and a status label of “ ”, i.e., no label, to make status indicator 550cl, produces output 590 equal to status indicator 550cl, and ends.

Output 590 is displayed via user interface element 210.

In method 500, user interface element 210 is described as representing node 120a, circuit 115a, substation 110 and region 105a. However, user interface element 210 can, more generally, represent any component, or aggregation of components, in an electrical power grid. For example, user interface element 210 may represent aggregations of nodes based on a hierarchy of geographic areas, e.g. a zip code, a municipality, and a state.

The electrical power grid is thus organized in a hierarchical tree, and user interface element 210 represents a subset of the hierarchical tree that includes a particular node, e.g. node 120a, as a subordinate. Generally, the node is a member of a first hierarchical level of the hierarchical tree, and the first hierarchical level is a member of a second hierarchical level of the hierarchical tree, and user interface element 210 represents a hierarchical level of the hierarchical tree. For example, node 120a is a member of circuit 115a, which is a member of substation 110a, and user interface element 210 can represent substation 110a. Similarly, a node can be a member of a zip code, which is a member of a municipality, and user interface element 210 can represent the municipality.

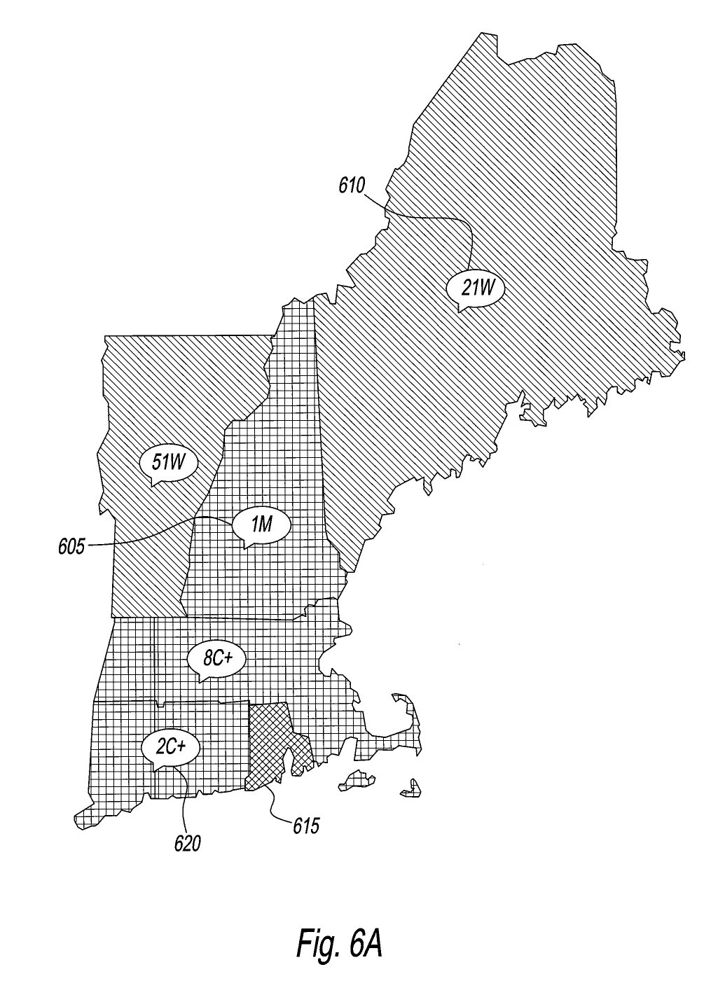

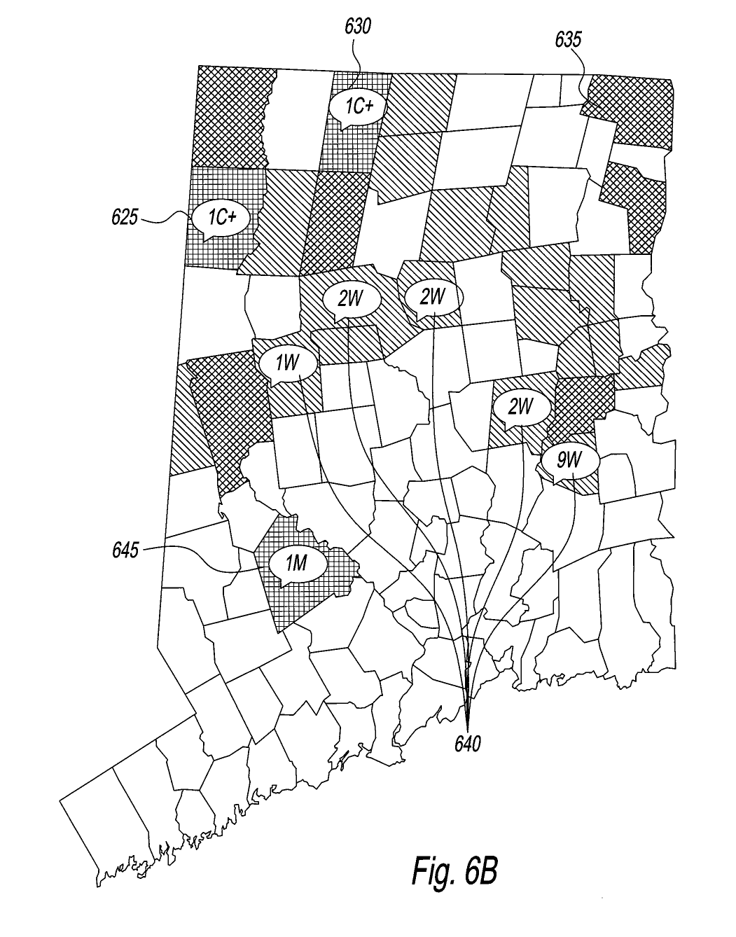

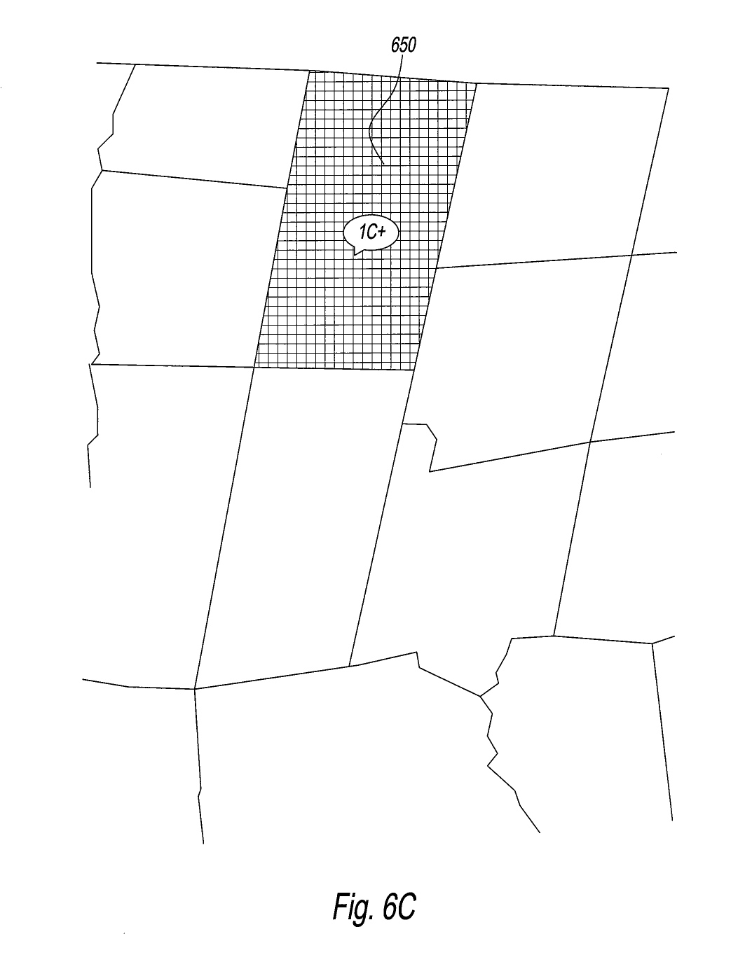

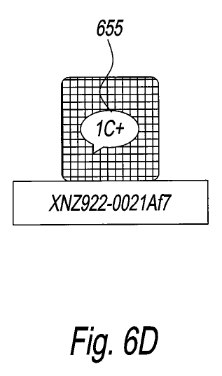

FIGS. 6a, 6b, 6c, and 6d are screenshots of maps depicting status indicators for an exemplary hierarchy of aggregations that represent states, cities, and zip codes; states contain cities, cities contain zip codes, and zip codes contain nodes.

FIG. 6a is a map of the New England area depicting status indicators for aggregations that represent states. Each state is color-coded to indicate the status of the aggregations in the state. Thus, the color-coding of the state is itself an indicator of status. However, additional status information may be further indicated by a status label, which may also have a color similar to, but perhaps a different shade as compared to, that of the state is which it is situated. New Hampshire is red and has a status label 605 of “1M”, indicating that nodes in New Hampshire have sent one major status message and no other status messages. Maine is yellow and has a status label 610 of “21W”, indicating that nodes in Maine have sent 21 warning status messages and no other status messages. Rhode Island, designated by reference number 615, is green but has no status label, indicating that nodes in Rhode Island are clear, i.e., have sent no status messages. Connecticut is red and has a status label 620 of “2C+”, indicating that nodes in Connecticut have sent two critical status messages and also other types of status messages.

FIG. 6b is a map of western Connecticut depicting status indicators for aggregations that represent cities, and showing what a user would see after zooming in on the western portion of the state of Connecticut in the map depicted in FIG. 6a. The city of Sharon is red and has a status label 625 of “1C+”, indicating that nodes in Sharon have sent one critical status message and also other types of status messages. The city of Norfolk is red and has a status label 630 of “1C+”, indicating that nodes in Norfolk have sent one critical status message and also sent other types of status messages. Together, nodes in the two cities have sent two critical status messages and other types of status messages, ensuring that status label 620 (see FIG. 6a) must have a status label including ”C+” with the prepended number 2; the only way this preliminary value for status label 620 could change is if nodes in other Connecticut cities have sent more critical status messages, causing the prepended number to increase.

The city of Newtown is red and has a status label 645 of “1M”, indicating that nodes in Newtown have sent one major status message; this is encompassed by the “+” already in status label 620. The cities of Washington, Litchfield, Harwinton, Southington, and Meriden, among others, are yellow and have a set of status labels 640 including “W” with various prepended numbers, indicating that nodes in each city have sent the specified number of warning status messages but no other types of status messages; these are also encompassed by the “+” already in status label 620. The cities of Suffield and Windsor, among others, collectively designated by reference number 635, are green, but have no status label, indicating that nodes in each of these cities are clear.

FIG. 6c is a map of Norfolk, Conn. and surrounding areas depicting a status indicator for an aggregation that represents a zip code and showing what a user would see after zooming in on the city of Norfolk in the map depicted in FIG. 6b. The zip code of 06058 is red and has a status label 650 of “1C+”, indicating that nodes in Norfolk have sent one critical status message and also other types of status messages. There are no other zip codes in Norfolk, so status label 630 (see FIG. 6b) is the same as status label 650.

FIG. 6d is a map of a portion of zip code 06058, located in Norfolk, Conn., depicting a status indicator for a node and showing what a user would see after zooming in on the zip code of 06058 in the map depicted in FIG. 6c. The node XNZ922-0021f7 is red and has a status label 655 of “1C+”, indicating that this node has sent one critical status message and also other types of status messages. If there are any other nodes in zip code 06058, they must not have sent any critical status messages, although they may have sent status messages of lower severities.

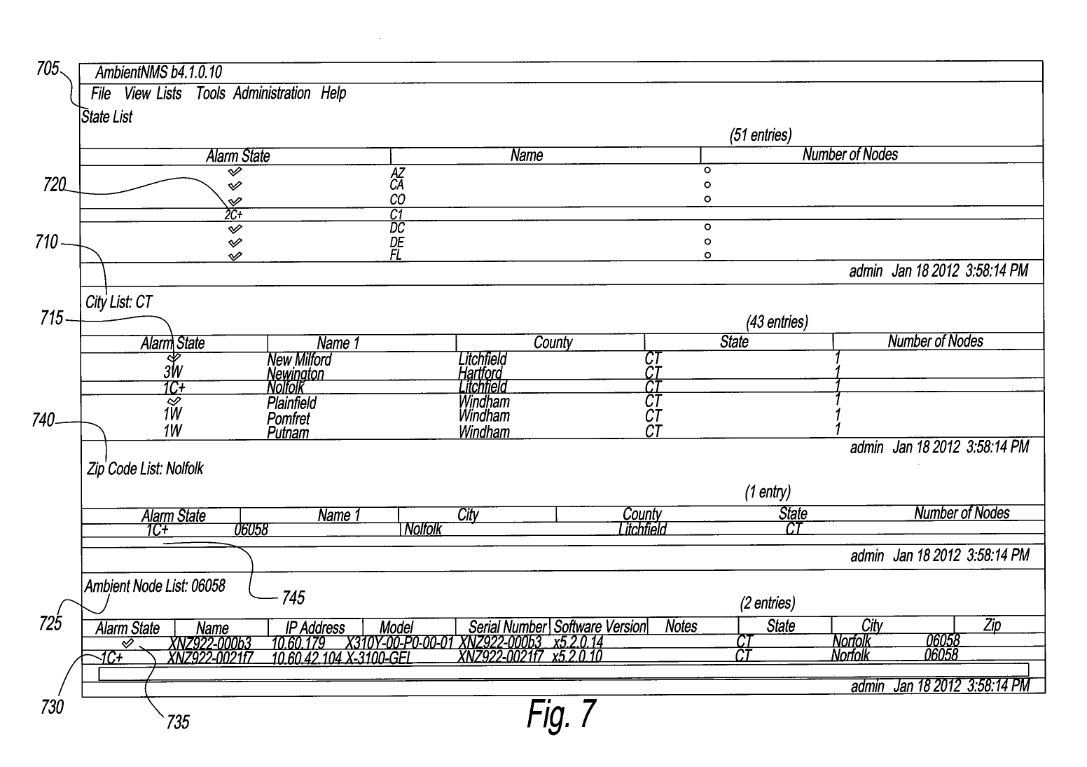

FIG. 7 is a screenshot of a series of lists depicting status indicators for an exemplary hierarchy of aggregations that represent states, cities, and zip codes. A list 705 includes several states; the row for Connecticut has a status indicator 720 of “2C+” with a red status color, the same as status label 620. A list 710 includes several cities in Connecticut and shows what a user would see after expanding list 705; the row for Norfolk has a status indicator 715 of “1C+” with a red status color, the same as status label 630. A list 740 includes the zip code(s) in Norfolk and shows what a user would see after expanding list 710; the row for 06058 has a status indicator 745 of “1C+” with a red status color, the same as status label 650. A list 725 includes the nodes in zip code 06058 and shows what a user would see after expanding list 740; the row for node XNZ922-0021f7 has a status label 730 of “1C+” with a red status color, the same as status label 655. Note that the row for node XNZ922-0000b3 has a status indicator 735 of a green check-mark, which is the equivalent in a list of a green status color with no status label on a map; this is another node in zip code 06058 that was not visible in the map depicted in FIG. 6d but, as predicted, did not change status label 650.

The techniques described herein are exemplary, and should not be construed as implying any particular limitation on the present disclosure. It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

The terms “comprises” or “comprising” are to be interpreted as specifying the presence of the stated features, integers, steps or components, but not precluding the presence of one or more other features, integers, steps or components or groups thereof. The terms “a” and “an” are indefinite articles, and as such, do not preclude embodiments having pluralities of articles.

What is claimed is:

1. A method comprising:
accessing a data structure that (i) represents a plurality of nodes in an electrical power grid, and (ii) contains data indicative of an event reported by a node in said plurality of nodes; and
presenting, on a user interface, an element that represents said plurality of nodes, in aggregate, and indicates an existence of said event.

2. The method of claim 1,
wherein said event has a level of severity, and
wherein said element indicates said level of severity.

3. The method of claim 2,
wherein said data structure contains data indicative of a plurality of events having said level of severity being reported by nodes in said plurality of nodes,
wherein said method further includes counting said events, thus yielding a total number of said events, and
wherein said element indicates said total number of said events.

4. The method of claim 1,
wherein said electrical power grid is organized in a hierarchical tree, and
wherein said element represents a subset of said hierarchical tree that includes said node as a subordinate.

5. The method of claim 4,
wherein said node is a member of a first hierarchical level of said hierarchical tree, and said first hierarchical level is a member of a second hierarchical level of said hierarchical tree, and
wherein said element represents said second hierarchical level.

6. The method of claim 5,
wherein said first hierarchical level is a first geographic area, and said second hierarchical level is a second geographic area.

7. A system comprising:
a processor; and
a memory that contains instructions that are readable by said processor to cause said processor to:
access a data structure that (i) represents a plurality of nodes in an electrical power grid, and (ii) contains data indicative of an event reported by a node in said plurality of nodes; and
present, on a user interface, an element that represents said plurality of nodes, in aggregate, and indicates an existence of said event.

8. The system of claim 7,
wherein said event has a level of severity, and
wherein said element indicates said level of severity.

9. The system of claim 8,
wherein said data structure contains data indicative of a plurality of events having said level of severity being reported by nodes in said plurality of nodes,
wherein said instructions further cause said processor to count said events, thus yielding a total number of said events, and
wherein said element indicates said total number of said events.

10. The system of claim 7,
wherein said electrical power grid is organized in a hierarchical tree, and
wherein said element represents a subset of said hierarchical tree that includes said node as a subordinate.

11. The system of claim 10,
wherein said node is a member of a first hierarchical level of said hierarchical tree, and said first hierarchical level is a member of a second hierarchical level of said hierarchical tree, and
wherein said element represents said second hierarchical level.

12. The system of claim 11,
wherein said first hierarchical level is a first geographic area, and said second hierarchical level is a second geographic area.

13. A storage medium that is tangible, and that comprises instructions that are readable by a processor to cause said processor to:
access a data structure that (i) represents a plurality of nodes in an electrical power grid, and (ii) contains data indicative of an event reported by a node in said plurality of nodes; and
present, on a user interface, an element that represents said plurality of nodes, in aggregate, and indicates an existence of said event.

14. The storage medium of claim 13,
wherein said event has a level of severity, and
wherein said element indicates said level of severity.

15. The storage medium of claim 14,
wherein said data structure contains data indicative of a plurality of events having said level of severity being reported by nodes in said plurality of nodes,
wherein said instructions further cause said processor to count said events, thus yielding a total number of said events, and
wherein said element indicates said total number of said events.

16. The storage medium of claim 13,
wherein said electrical power grid is organized in a hierarchical tree, and
wherein said element represents a subset of said hierarchical tree that includes said node as a subordinate.

17. The storage medium of claim 16,
wherein said node is a member of a first hierarchical level of said hierarchical tree, and said first hierarchical level is a member of a second hierarchical level of said hierarchical tree, and
wherein said element represents said second hierarchical level.

18. The storage medium of claim 17,
wherein said first hierarchical level is a first geographic area, and said second hierarchical level is a second geographic area.
